(19) United States
(12) Patent Application Publication
(10) Pub. No.: US 2020/0092956 A1
(43) Pub. Date: Mar. 19, 2020

(54) PORTABLE MICROWAVE OVEN

(71) Applicant: OXX PRODUCTS LLC, Grand Rapids, MI (US)

(72) Inventor: Jimmy Quang VIET-DOAN, Grand Rapids, MI (US)

(21) Appl. No.: 16/570,102

(22) Filed: Sep. 13, 2019

Related U.S. Application Data
(60) Provisional application No. 62/731,709, filed on Sep. 14, 2018.

(51) Int. Cl. H05B 6/64; H05B 6/80

(52) U.S. Cl. CPC H05B 6/642; H05B 6/6414; H05B 2206/04; H05B 6/80; H05B 6/6426

(57) ABSTRACT

A portable microwave oven that includes an outer housing comprising a plurality of outer walls, wherein one outer wall includes a vent opening; an inner structure comprising a plurality of inner walls that define a heating chamber; a door rotatable relative to the outer housing to access the heating chamber; a heating element configured to heat the heating chamber; and a heat handling system comprising: an intake duct fluidly connecting the vent opening to an electronics chamber housing the heating element; an exhaust duct fluidly connecting the electronics chamber to the vent opening; and at least one fan that is configured to draw air in through the intake duct or push air out through the exhaust duct; wherein the microwave oven is operable in a first orientation, in which the door is forward facing, and a second orientation, in which the door is upward facing.

### CROSS-REFERENCE TO RELATED PATENT APPLICATIONS

This application claims the benefit of and priority to U.S. Provisional Patent Application No. 62/731,709, filed Sep. 14, 2018. The aforementioned U.S. application is incorporated herein by reference in its entirety.

### BACKGROUND

The present application relates generally to the field of microwave ovens. More specifically, this application relates to portable microwave ovens that are configured to withstand outdoor environmental conditions and added abuse, such as stemming from the portability of the microwave oven.

### SUMMARY

At least one embodiment of the application relates to a portable microwave oven that includes an outer housing comprising a plurality of outer walls, wherein one outer wall of the plurality of outer walls includes a vent opening; an inner structure comprising a plurality of inner walls that define a heating chamber; a door rotatable relative to the outer housing to access the heating chamber; a heating element (e.g., magnetron) located inside the outer housing and configured to heat the heating chamber; and a heat handling system including: an intake duct fluidly connecting the vent opening to an electronics chamber housing the heating element; an exhaust duct fluidly connecting the electronics chamber to the vent opening; and at least one fan that is configured to draw air in through the intake duct or push air out through the exhaust duct. The microwave oven can be configurable to be operable in a first orientation, in which the door is forward facing, and a second orientation, in which the door is upward facing.

At least one embodiment of the application relates to a portable microwave oven that includes an outer housing, an inner structure, a door, a heating element, and a heat handling system. The outer housing includes a plurality of outer walls including a side wall, which includes a first vent opening, and an end wall, which includes a second vent opening. The inner structure includes a plurality of inner walls that couple to the plurality of outer walls and define a heating chamber. The door is rotatable relative to the outer housing to access the heating chamber. The heating element is located inside the outer housing and configured to heat the heating chamber. The heat handling system includes an intake duct fluidly connecting the first vent opening to an electronics chamber housing the heating element; an exhaust duct fluidly connecting the electronics chamber to the second vent opening; and at least one fan that is configured to draw air in through the intake duct or push air out through the exhaust duct. The microwave oven can be configurable to be operable in a first orientation, in which the door is forward facing, and a second orientation, in which the door is upward facing.

At least one embodiment of the application relates to a portable microwave oven that includes an outer housing, an inner structure, a door, and a heating element. The outer housing includes a plurality of outer walls. The inner structure includes a plurality of inner walls that define a heating chamber, and a plurality of intermediate walls, each intermediate wall positioned between an associated wall of each of the plurality of outer walls and the plurality of inner walls, wherein the inner structure couples to the outer housing. The door is rotatable relative to the outer housing to access the heating chamber. The heating element is located inside the outer housing and configured to heat the heating chamber. The microwave oven can be configurable to be operable in a first orientation, in which the door is horizontally facing, and a second orientation, in which the door is vertically facing.

Additional features, advantages, and embodiments of the present disclosure may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

FIG. 1 is a perspective view of an exemplary embodiment of a portable microwave oven, according to this application.

FIG. 2 is another perspective view of the portable microwave oven shown in FIG. 1.

FIG. 3 is another perspective view of the portable microwave oven shown in FIG. 1 with a door in an open position in a first use position.

FIG. 4 is another perspective view of the portable microwave oven shown in FIG. 1 with the door in an open position in a second use position.

FIG. 5 is a plan view of the portable microwave oven shown in FIG. 1.

FIG. 6 is a plan view of the portable microwave oven shown in FIG. 1.

FIG. 7 is a side view of the portable microwave oven shown in FIG. 1.

FIG. 8 is a perspective cross-sectional view of the portable microwave oven shown in

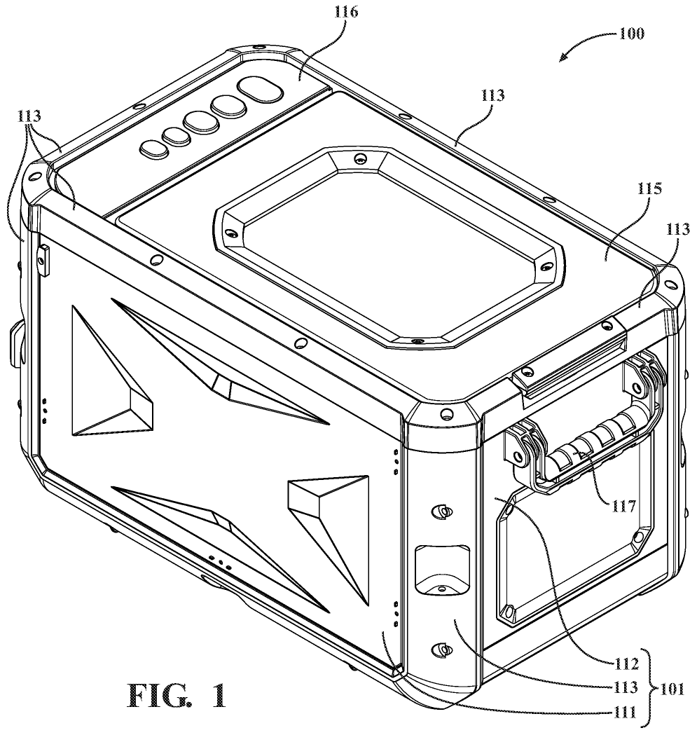

FIG. 1.

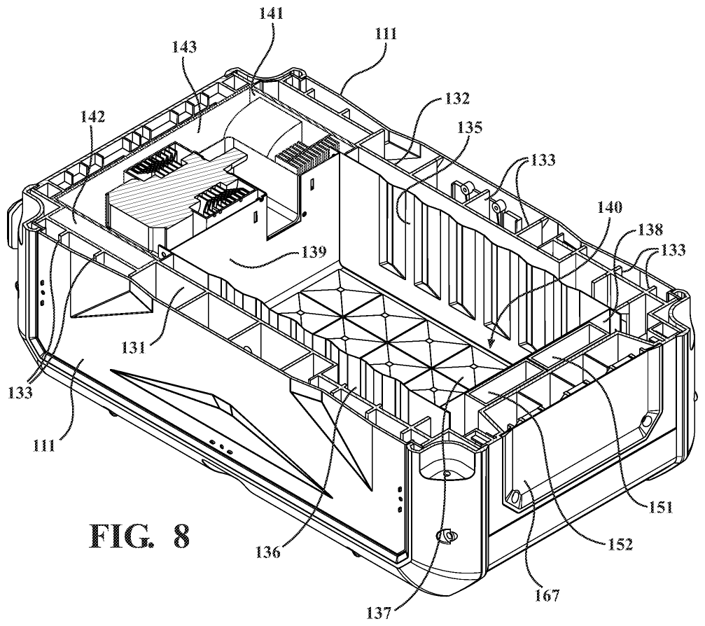

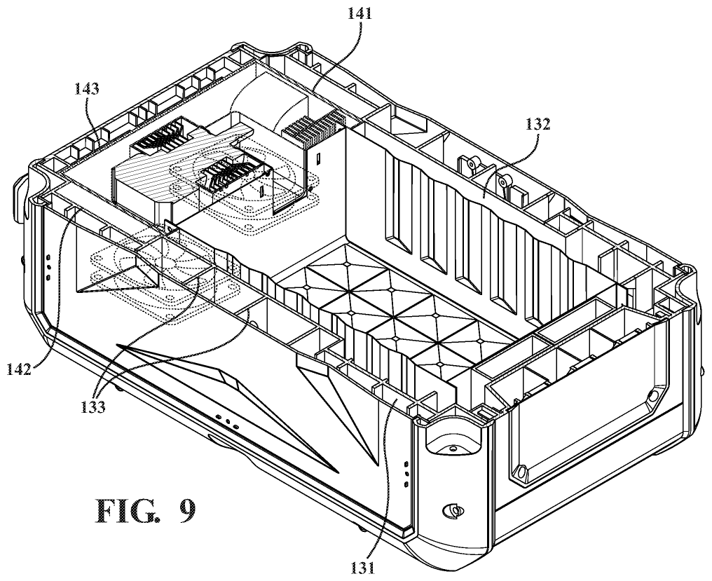

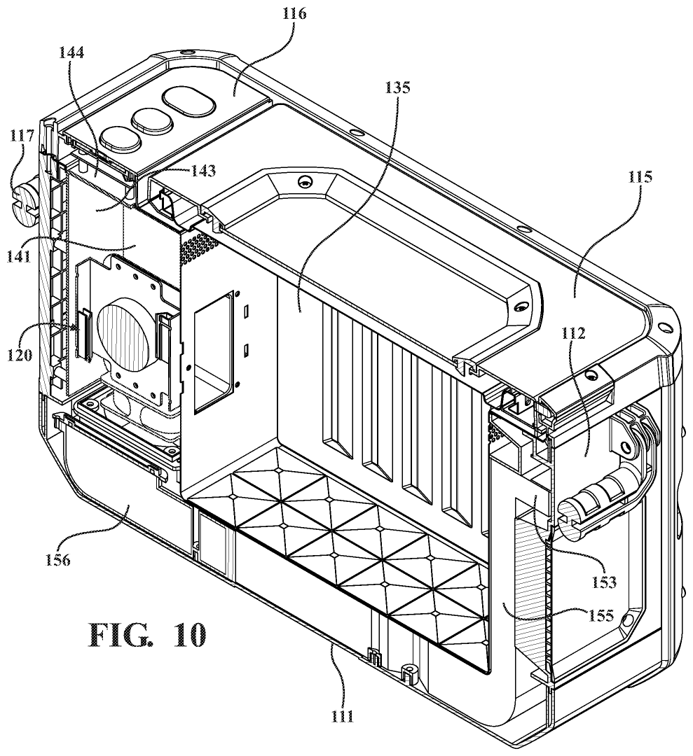

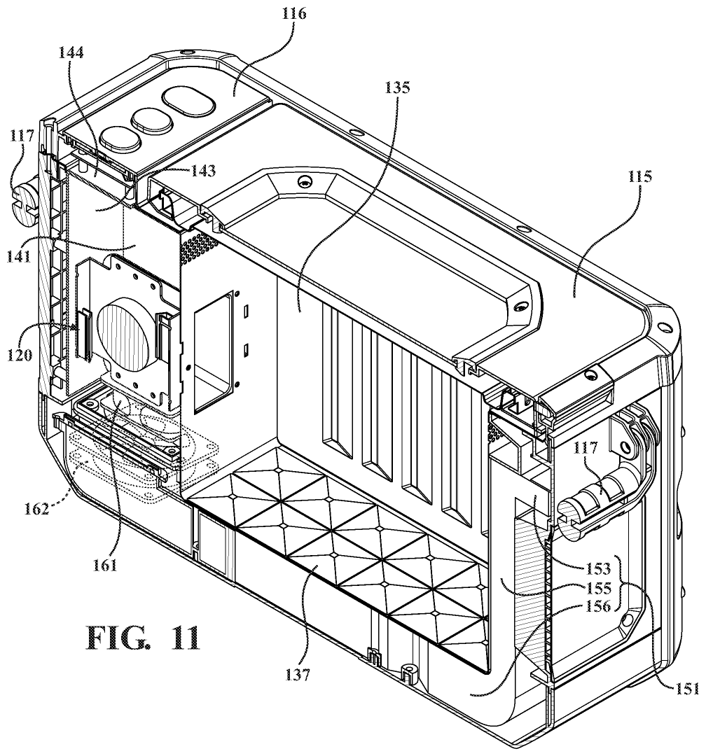

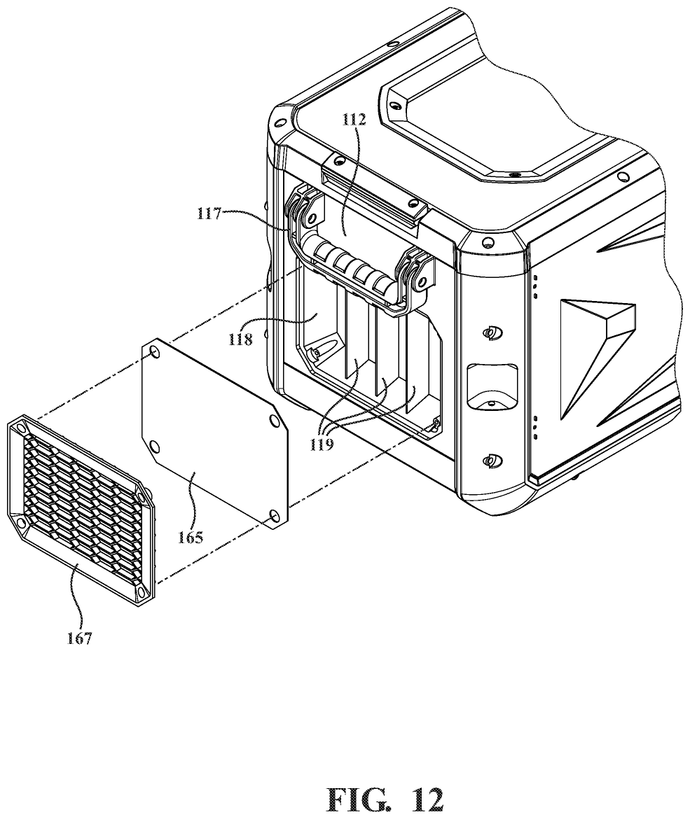

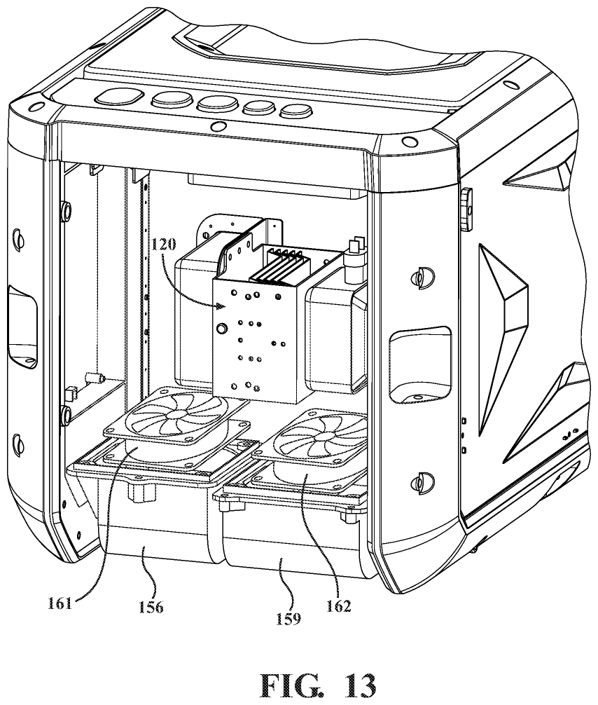

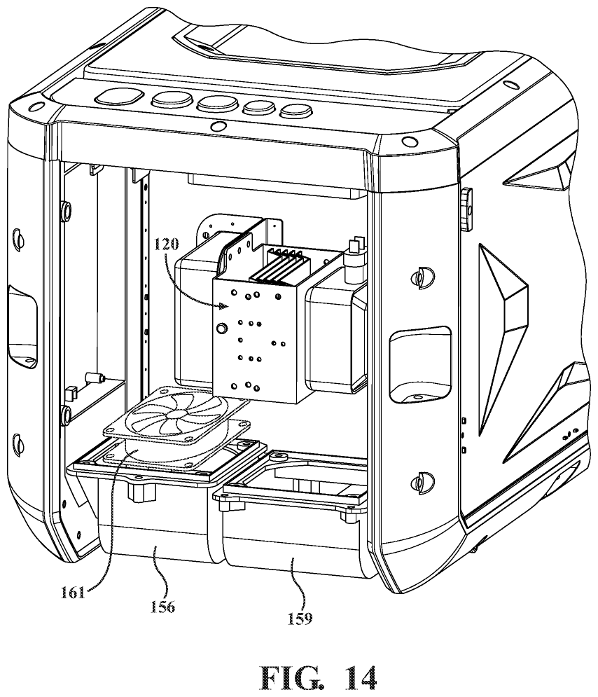

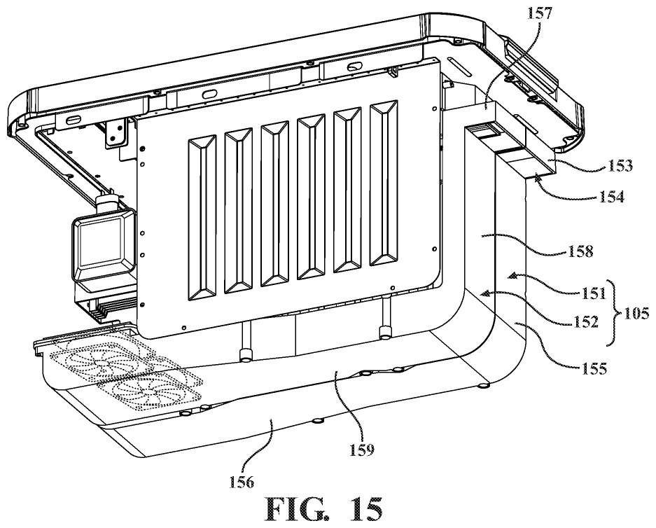

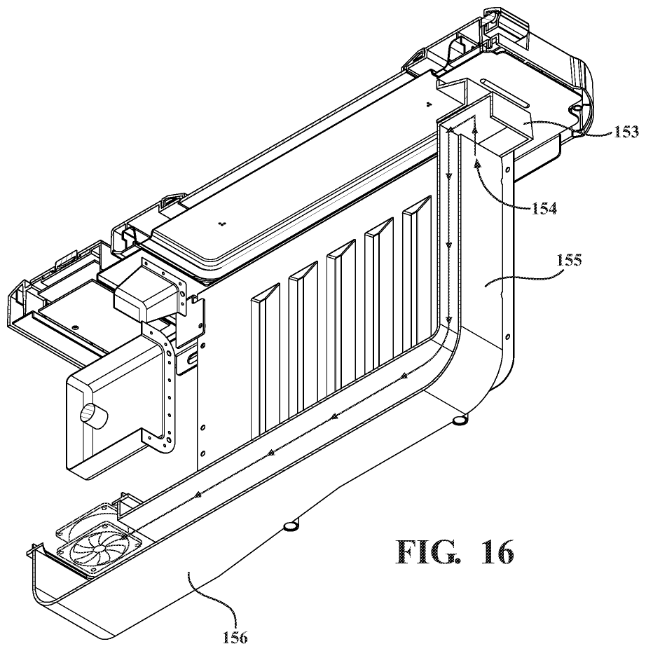

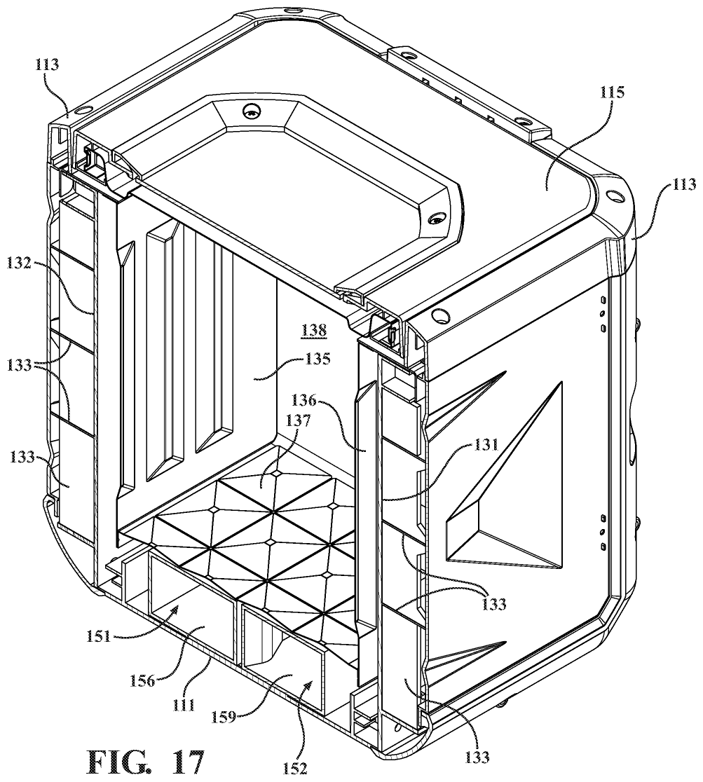

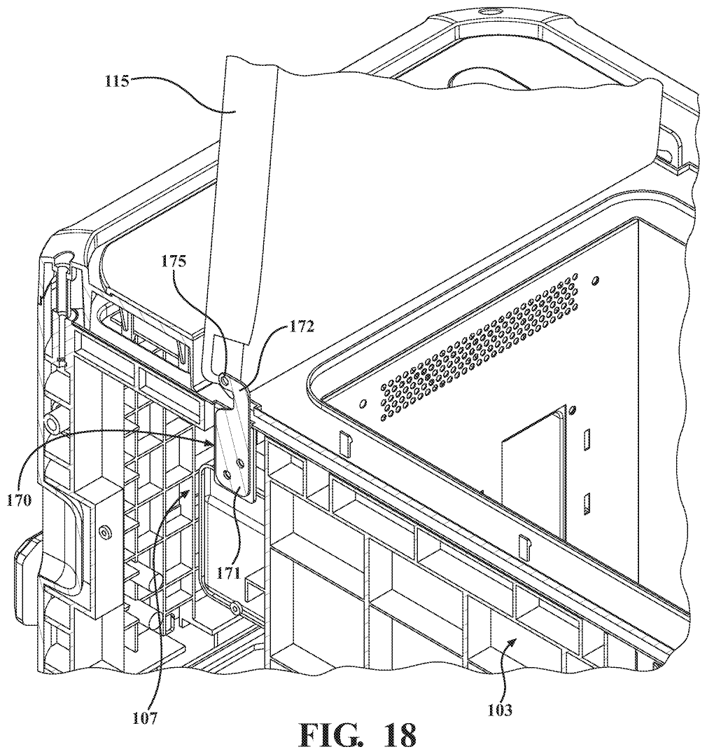

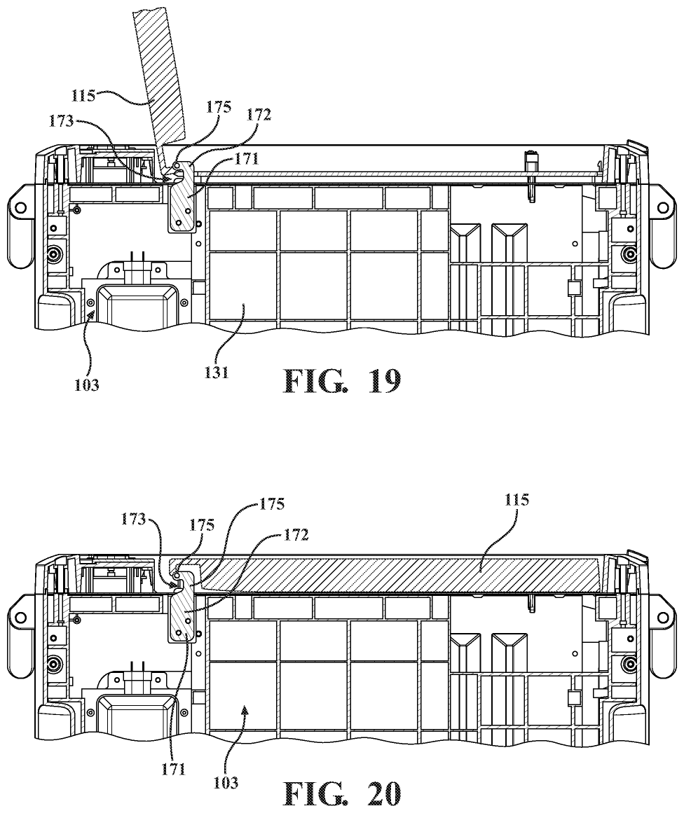

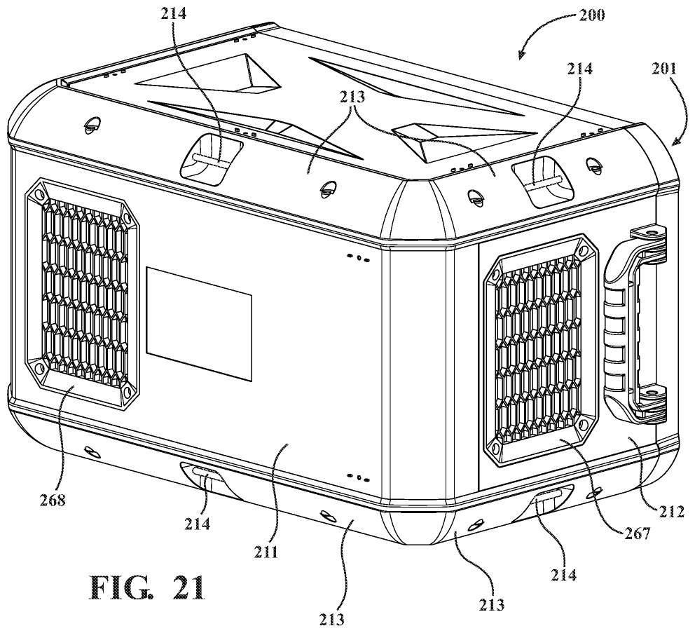

FIG. 9 is the cross-sectional view shown in FIG. 8 with some internal elements visible for clarity.

FIG. 10 is another perspective cross-sectional view of the portable microwave oven shown in FIG. 1.

FIG. 11 is the cross-sectional view shown in FIG. 10 with some internal elements visible for clarity.

FIG. 12 is a partially exploded perspective view of a portion of the portable microwave oven shown in FIG. 1.

FIG. 13 is a perspective view of the portable microwave oven shown in FIG. 1 with a portion of the housing removed to view internal elements.

FIG. 14 is another perspective view of the portable microwave oven shown in FIG. 1 with a portion of the housing removed to view internal elements.

FIG. 15 is a perspective view of a portion of the portable microwave oven shown in FIG. 1.

FIG. 16 is a perspective cross-sectional view of the portion of the portable microwave oven shown in FIG. 15.

FIG. 17 is a perspective cross-sectional view of a portion of the portable microwave oven shown in FIG. 1.

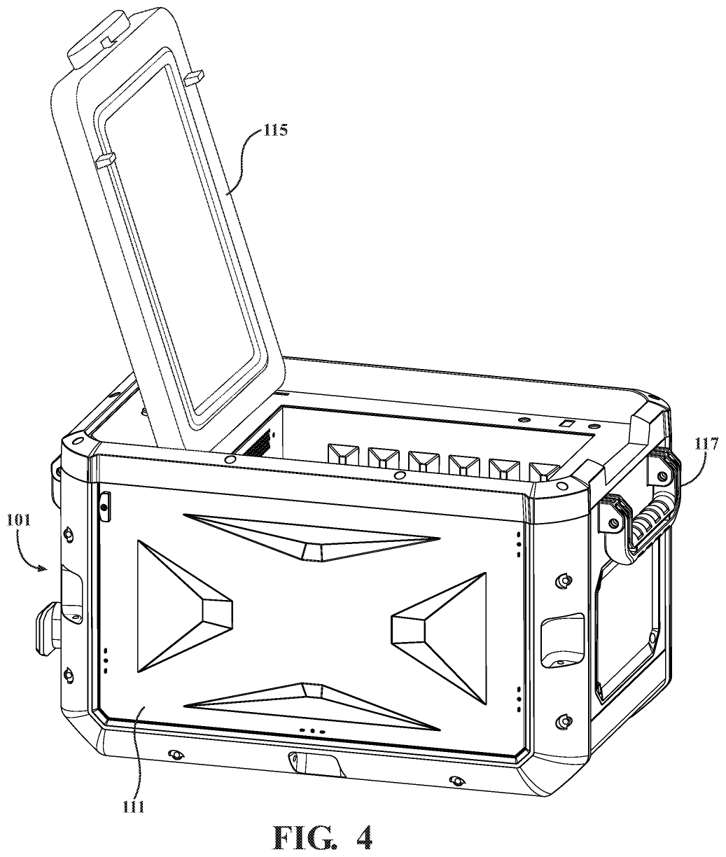

FIG. 18 is a perspective view of the portable microwave oven shown in FIG. 4 with a portion of the outer housing removed to show a hinge assembly and the door in an open position.

FIG. 19 is a side view of a portion of the portable microwave shown in FIG. 18.

FIG. 20 is a side view of the portion of the portable microwave shown in FIG. 19 with the door in the closed position.

FIG. 21 is a perspective view of another exemplary embodiment of a portable microwave oven, according to this application.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Disclosed herein are microwave ovens that are designed to be portable, rugged, and resistant to outdoor elements such as water, dust, impact, and vibration (e.g., from transportation). The microwave ovens include features that allow the microwave to perform in circumstances found on outdoor construction sites, camp sites, backyard settings, and other environments outside the home or kitchen. For example, such features provide protection from dust and water ingress, ultra-violet (UV) light protection for materials, and portability.

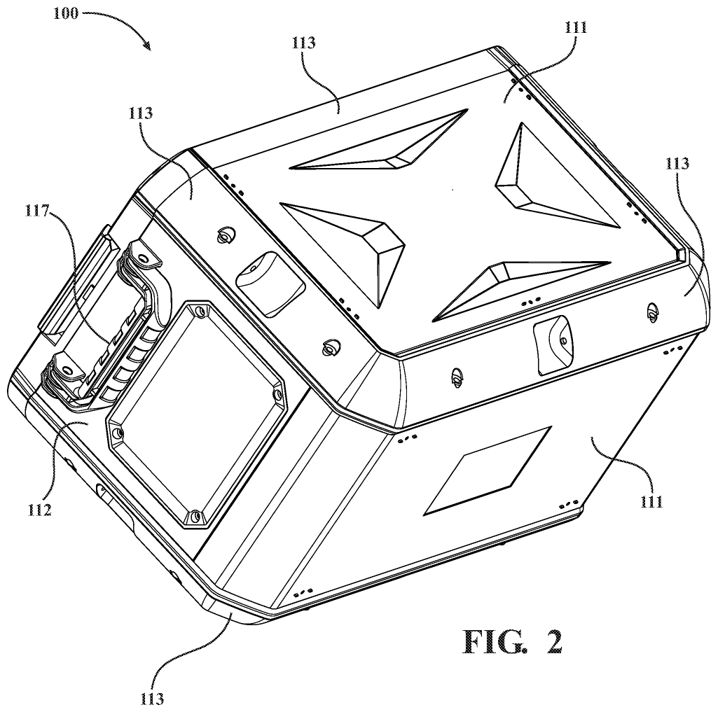

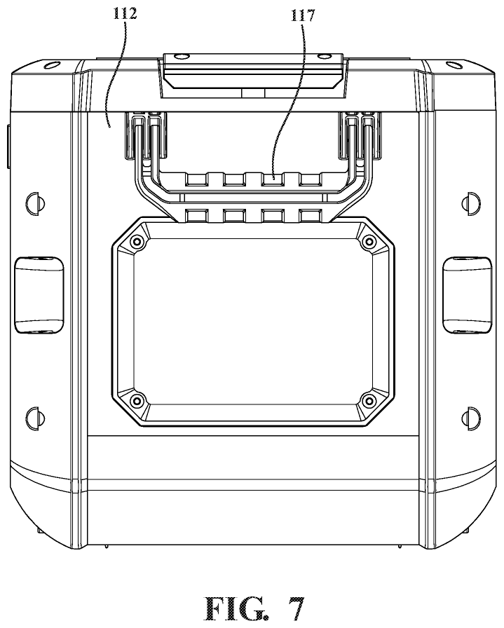

FIGS. 1-17 illustrate an exemplary embodiment of a portable microwave oven or microwave 100. Note that the terms “microwave oven” and “microwave” are used interchangeably in this application. Further, other terms, such as “appliance” are also used herein to refer to a microwave oven.

As shown in FIGS. 1-7, the microwave 100 includes an outer housing 101 (e.g., external casing, etc.) that is much stronger and more durable than conventional microwaves, as well as, preventing water and dust ingress except through the vent opening(s). The illustrated outer housing 101 includes a plurality of panels that are interconnected to form a substantially cuboidal (e.g., hexahedral) shape, although the outer housing 101 can have other suitable shapes. The plurality of panels includes several side panels 111 (e.g., side walls, etc.), opposite end panels 112 (e.g., end walls), and corner panels 113 (e.g., corners, etc.), which are positioned between adjacent side panels 111 as well as adjacent side and end panels. The design and construction of the outer housing 101 protects the microwave 100 from ingress of, among other elements, water and dust or dirt since the various panels (side panels, end panels, corner panels) are interconnected in a water tight manner. Each panel of the outer housing 101 is water resistant and includes a material that provides such, and the plurality of panels are coupled together in a manner that forms an airtight and watertight seal (e.g., hermetic seal) between coupled panels. Further, the panels of the outer housing 101 are configurable to have a relatively higher impact resistance compared to conventional microwaves in view of the likelihood of the abuse the microwave 100 will endure given the portable nature of the appliance. For example, each panel can include polycarbonate (PC) and/or polybutylene terephthalate (PBT), where a silicone (or similar) adhesive couples the panels together to form the airtight and watertight seal. According to other examples, materials such as acrylonitrile butadiene styrene (ABS), polypropylene (PP), polyethylene (PE), steel, aluminum, and/or graphene can be used alone or in combination with any of the other materials (or similar materials) disclosed herein to provide the water resistance and high impact strength desired. Mechanical fasteners can optionally be used (e.g., in addition to adhesive) to couple the panels together and/or to couple the panels to other elements of the microwave 100, such as to increase the strength and durability of the outer housing 101. Traditional microwave ovens generally include two thin pieces of bent steel as the outer housing, which does not stand up well to physical abuse or shock. Thus, the structure (e.g., outer housing 101) of the microwave 100 is able to withstand much more abuse, such as industry standard shipping/handling drop tests and proprietary manufacturer requirement of a one meter drop of the unpackaged product on a concrete surface. Further, the individual panels of the outer housing 101 can be replaced in the event of damage rather than replacing the whole outer structure, like with traditional microwaves.

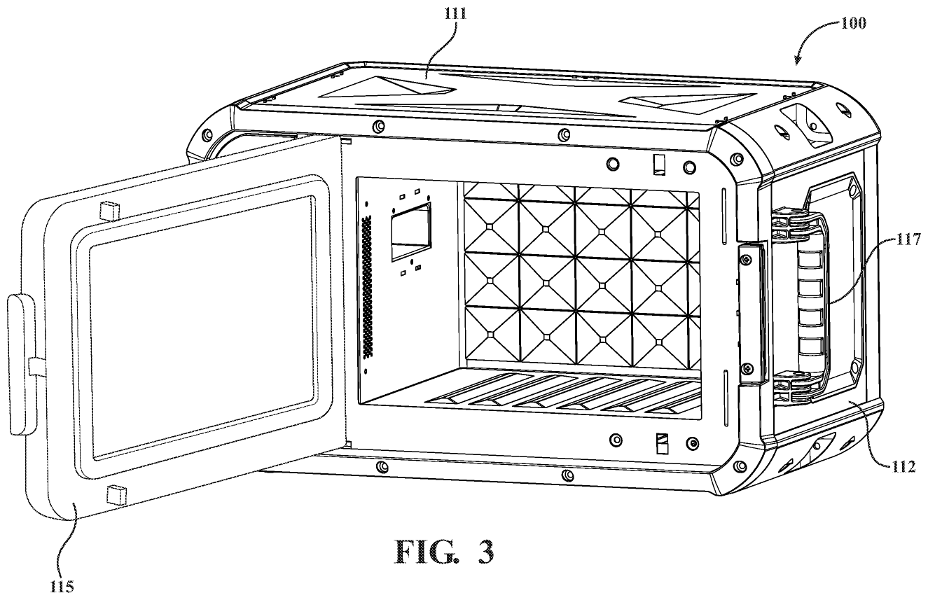

The illustrated microwave 100 also includes a door 115 that is configured to nest with the outer housing 101 (e.g., surrounding corner panels 113) in a closed position, as shown in FIG. 1, thereby forming one side of the hexahedral shape. When the door 115 is in the closed position relative to the outer housing 101, an airtight and watertight seal is formed between the door 115 and the outer housing 101 to prevent ingress of air and liquid to an interior cavity of the microwave 100. Such seal also prevents the ingress of dust and dirt into the internal cavity between the door 115 and the adjacent panels of the outer housing 101. The door 115 is rotatable relative to the outer housing 101 about a pivot axis defined by a pair of internal hinges 107 (e.g., hinge assemblies, etc.) from the closed position to an open position, such as shown in FIGS. 3 and 4, where a first hinge 107 is coupled to a first side of the door 115 and a second hinge 107 is coupled to a second side of the door 115. Locating the hinges 107 inboard from an end, corner, and/or side of the housing 101 is advantageous over designs having external hinges located on, for example, the outside corner or end of the appliance, since the internal hinges 107 are protected (by the outer housing 101) from shock or impact damage (e.g., from dropping the microwave 100, from dropping something onto the microwave 100, etc.). This arrangement also better protects the door 115 by nesting (e.g., recessing) the door 115 within the structural outer housing 101. As shown in FIGS. 1 and 6, in the closed position, an outer surface of the door 115 is flush with or recessed inwardly from an outer surface of the surrounding outer housing 101. With this arrangement, if dropped, the microwave 100 will not land on the door as the first part of impact and, therefore, the surrounding outer housing 101 protects the door 115 and hinges from damage. Further, the sides of the door 115 extend into the opening of the outer housing 101 adjacent to the structure thereof (e.g., the corner panels 113, side panels 111, etc.) and form a seal with the adjacent structure. Given the portable nature of the microwave 100, protecting the hinges and door are even more important to ensure an effective seal between the door 115 and the surrounding panels of the outer housing 101. Traditional microwaves locate the hinge on an outside corner of the application, because they are not designed to be portable (i.e., repeatedly transported, carried, or relocated frequently) so there is no need to protect the hinge in the same way as here. As such, traditional designs use cheaply assembled and manufactured hinges that would not hold up to damage if the microwave were portable.

FIGS. 18-20 illustrate one of the internal hinges 107 (e.g., the first hinge) that rotatably couple the door 115 to the internal structure 103. FIGS. 18 and 19 illustrate the door 115 rotated into an open position relative to the internal structure 103; and FIG. 20 illustrates the door 115 rotated into a closed position. The illustrated hinge 107 includes a pivot bracket 170 having a generally rectangular base 171, which is coupled to one or more elements of the internal structure 103 (e.g., the first intermediate side wall 131, one or more ribs 133, etc.) through one or more mechanical fasteners, and an arm 172, which extends upwardly from the base 171. The arm 172 has a hook shape with a notch 173, which can receive part of the door 115 (e.g., a rear flange or wall), such as in the open position shown. A distal end of the arm 172 is configured to receive a pivot member 175 (e.g., pivot pin), such as through an opening in the distal end, to rotatably couple the door 115 to the pivot bracket 170. As shown best in FIGS. 19 and 20, the entire pivot bracket 170 (e.g., including the arm 172) is advantageously positioned inside of or within the outer profile of the internal structure 103 (e.g., the arm 172 is below the upper surface(s) of the internal structure 103 in the side views shown in FIGS. 19 and 20). This arrangement protects the hinges 107 from damage (e.g., as discussed above). Similarly, the door 115 can be positioned within the outer profile of the internal structure 103 to protect the door 115 and the hinges 107 from damage. It is noted that the other hinge (e.g., the second hinge 107) can be configured the symmetrically opposite form or basically the same as the first hinge described above.

As shown in FIGS. 3 and 4, the microwave 100 is designed to operate in at least two different physical orientations. In a first orientation, as shown in FIG. 3, the door 115 is front or forward facing and rotates about a vertical pivot axis in a horizontal plane (like traditional microwaves). In a second orientation, as shown in FIG. 4, the door 115 is upward facing and rotates about a horizontal pivot axis in a vertical plane. That is, the door 115 opens vertically towards the sky or ceiling to allow for ease of operation, such as when there is no counter or surface, other than the floor or ground height, in which to place and operate the microwave 100. Further, provisions are provided internally to provide a cooking performance in both possible food positions, i.e., the first and second orientations, without a significant degradation in performance. As an example, a significant degradation is considered in the range of twenty to twenty-five percent or greater. The design of the microwave specifically guides sufficient microwave energy to these two food placement positions. For example, the structure of the microwave 100 is configured to properly vent heat in both positions/orientations, as discussed herein. In contrast, conventional microwaves typically have vents located in the rear wall opposite the door, so would be unable to operate in this second orientation, since doing so would limit ventilation and could lead to overheating of the appliance. It is noted that the door 115 of the illustrated microwave 100 is set up to accommodate right handed users, and that the door 115 could be configured to open from the opposite side to accommodate left handed users.

Additional provisions are included to limit ingress and promote egress of water and solid particulate (e.g., dust) when the microwave 100 is operated or stored in both positions. As discussed herein, the structure (e.g., intake duct, exhaust duct, door seal, etc.) is configured to prevent water, such as droplets in the airstream, water splashing onto the appliance, or rain from entering the appliance. Further, the filter, which can be a foam filer or another type of filer, also aids in providing water protection. Drain holes can be included (e.g., in a bottom part of one or both of the intake and exhaust ducts, near one or more feet on side wall, etc.) to facilitate drainage in the event water enters the appliance. Hinged louvers can be provided to selectively close the intake and/or exhaust duct openings, such as when appliance is not running to prevent ingress of water/air through the openings. The door can include a self-closing feature, which is configured to shut the door after predetermined period of time that the door is open.

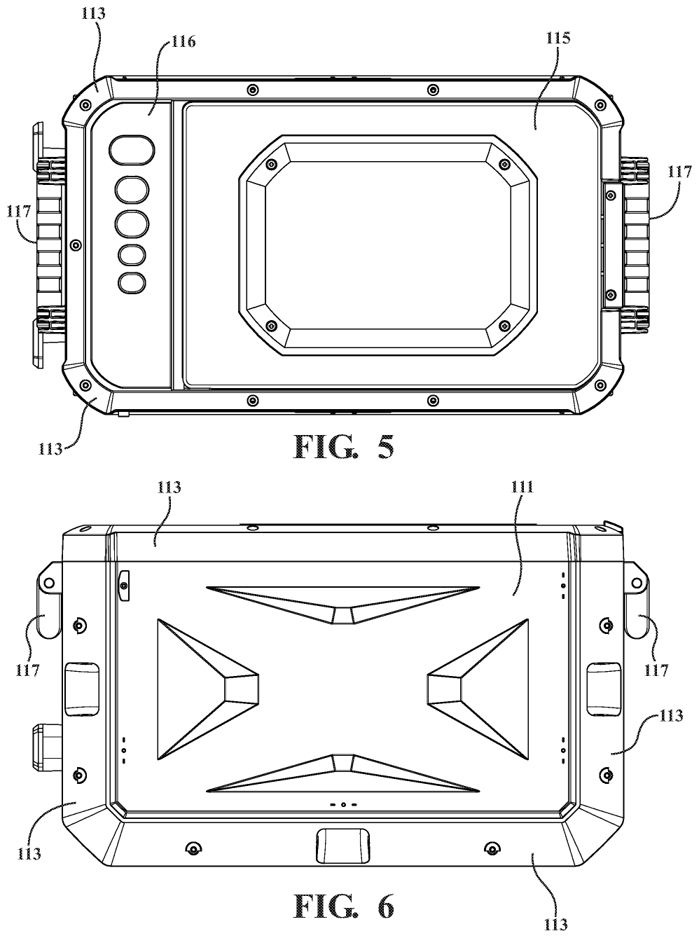

As shown in FIGS. 1 and 5, the microwave 100 includes a control panel 116, such as provided adjacent to the door 115. The illustrated control panel 116 is located between an end of the door 115 that is adjacent to the hinges 107 and other panels of the outer housing 101 (e.g., corner panels 113). The control panel 116 can include buttons and/or a touch sensitive screen that allows a user to input parameters (e.g., time, heat setting, etc.) for controlling operation of the microwave 100. The control panel 116 can include a display, such as a liquid-crystal display or other suitable type of display, for outputting information to the user (e.g., cook time remaining, clock, etc.).

As shown in FIGS. 5 and 6, the microwave 100 includes a pair of handles 117 located on opposite ends of the outer housing 101 to facilitate easy transport (i.e., portability) by allowing a user to carry the microwave 100 with the handles 117. Each handle 117 is illustrated as being tubular with a U-shape and having two ends that are pivotally coupled to the associated end panel 112 through pivot brackets and pivots. In this way, each handle 117 can rotate about the associated pivot/pivot bracket relative to the end panel 112. Additionally, rotation stops are provided to limit travel of each handle 117 to prevent a pinch hazard to the user's fingers while carrying the appliance. The handles 117 further facilitate securing the microwave 100, such as during transportation to and from different job sites.

The microwave 100 includes an internal heating element, such as a magnetron 120, which produces the microwave radiation or electromagnetic radiation for heating the contents (e.g., food, drink) inside the microwave 100, and an electronic controller (e.g., microcontroller) that controls the magnetron 120, such as in response to input through the control panel 116. The electronic controller can include one or more printed circuit boards that communicate with the magnetron 120 and the control panel 116. A power management circuit board is provided to convert the supply power, such as from an externally connected power supply or standard AC voltage outlet, to electrical power of a suitable voltage and frequency necessary to operate the magnetron 120. The microwave 100 includes additional structure to support the magnetron 120, such as during a drop or impact event, given the portability of the appliance.

The microwave 100 includes a unique system for safe handling and dispersion of the heat generated by the heating element and other electrical components in the microwave oven electronics chamber (e.g., magnetron, circuit boards, controller, etc.). The heat handling system of the microwave 100 includes a duct assembly 105. As shown best in FIGS. 15-17, the duct assembly 105 includes a first or intake duct 151 and a second or exhaust duct 152 that are disposed adjacent to (e.g., side by side with) one another. Each duct 151, 152 is configured to provide a torturous path for air flow that advantageously helps to prevent water and dirt ingress. The illustrated intake duct 151 includes a first or inlet section 153 that extends generally horizontally (e.g., when the microwave 100 is in the second orientation). As shown in FIG. 10, the inlet section 153 is located closer to the door 115 than the side panel 111 opposite the door 115. In this way, the inlet section 153 is elevated off the ground (or other support) when the microwave 100 is in the second orientation. The inlet section 153 is closed, but for an inlet opening 154, which is located in a bottom (e.g., underside) of the inlet section 153. The illustrated intake duct 151 includes a second or down section 155 that extends substantially transverse to the inlet section 153. As shown in FIG. 10, the down section 155 is positioned inboard of an end panel 112 of the outer housing 101 to allow room for a filtering element to be located to filter air coming into the intake duct 151 (discussed below). The down section 155 extends generally down to the side panel 111 (opposite the door 115), where the down section 155 meets (e.g., transitions into) a third or elongated section 156, which extends along the inside of the side panel 111 toward and proximate the opposite end panel 112. The illustrated elongated section 156 has an outlet that opens into an internal chamber (e.g., electronics chamber) housing the magnetron and other electrical components of the system.

The illustrated exhaust duct 152 has the same basic structure as the intake duct 151, except the airflow direction is reversed. Thus, the illustrated exhaust duct 152 includes a first or outlet section 157, which is configured basically the same as the inlet section 153, a second or down section 158, which is configured basically the same as the down section 155, and a third or elongated section 159, which is configured basically the same as the elongated section 156, as shown in FIG. 15.

As shown in FIG. 16, air enters the intake duct 151 through the inlet opening 154, passes through the inlet section 153, then turns downward passing through the down section 155, then turns back horizontally passing through the elongated section 156 and out the outlet into the internal chamber. The air can cool the electronic components in the internal chamber via convection, and then the air passes into an inlet in the elongated section 159 of the exhaust duct 152. The air flows through the elongated section 159, up the down section 158, then into the outlet section 157 and out through an outlet in the outlet section 157. In this way, heat handling system of the microwave 100 brings fresh cooler air into the intake duct 151 from one end of the appliance, routes the air to the other end of the appliance in which the electronics are located to cool the electronics, then routes the heated air away from the electronics through the exhaust duct 152, expelling the heated air through the outlet of the exhaust duct 152. This arrangement may allow the inlet and exhaust ducts 151, 152 to be manufactured as a single piece component (e.g., a unitary member), depending on the fabrication method utilized. As shown in FIG. 17, the box shaped design of the sections 156, 159 of the ducts 151, 152 also provides structural support to inner structure (e.g., a floor or shelf) while reducing the package space utilized for routing air. It is noted that ducts 151, 152 could be formed separately and located proximate to one another or located apart from one another or have opposite air flow directions (inlet on one panel and outlet on a different (e.g., opposite) panel). Also, for example, the exhaust duct 152 could be shorter in length and exit through a different opening.

The heat handling system also includes one or more fans located in the flow path of air to help move the air through the system. As shown in FIGS. 13 and 15, a first fan 161 is located proximate to (e.g., between) the outlet of the elongated section 156 (of the intake duct 151) and the internal electronics chamber, where the first fan 161 pulls fresh cooler air through the intake duct 151 and pushes this air into the electronics chamber and across the electronic components in the chamber. Also shown, a second fan 162 is located proximate to the inlet of the elongated section 159 (of the exhaust duct 152) and the internal electronics chamber, where the second fan 162 pulls the air in the chamber across the electronics and pushes the air into the exhaust duct 152 to be expelled from the appliance, as discussed herein. The system can operate with a single fan, such as only the first fan 161 as shown in FIG. 14. However, the dual fan system may provide equivalent or additional mass air flow (i.e., cooling efficiency) relative to a single fan system with the benefit of enabling the design of a smaller, more compact product housing. A further advantage of a multiple fan system is to overcome flow impedance of large components and changes of flow direction downstream of obstructions (e.g., inverter circuit board, magnetron).

The illustrated heat handling system of the microwave 100 includes a filtered vent on the end of the appliance that is opposite the electronics and is proximate the inlet into the intake duct 151 and outlet of the exhaust duct 152. As shown in FIG. 12, the end panel 112 includes an opening defined by a mouth 118 and a plurality of fins 119. The mouth 118 has an open rectangular shape and the plurality of fins 119 are disposed in the opening in a parallel and offset arrangement from one another. The mouth 118 and the fins 119 are recessed inwardly relative to the end panel 112 such that when a filter 165 and a filter cover 167 are received in the recess, an outside of the filter cover 167 can be relatively flush with the end panel 112. The filter 165 has a dual purpose to filter intake air and limit ingress through the exhaust port, such as to remove particles (e.g., dust, dirt, etc.) from the fresh air intake that will lessen the buildup of dust and particulates on the electronics and contribute to the cooler operating temperature of the system. The portion of the filter covering the exhaust port will limit the ingress of water and dust through the exhaust port. The filter 165 is sized to complement the opening in the mouth 118; and the filter cover 167, similarly, is sized the same, fitting over the filter 165 and complementing the mouth 118. The filter cover 167 forms an outside wall of the appliance and can be held in place by one or more removable mechanical fasteners (e.g., screws, bolts, etc.) and/or through one or more snap features (e.g., detent snap). As shown in FIG. 12, the filter cover 167 includes an outer frame having holes in the corners for receiving mechanical fasteners that couple to threaded openings in the corners of the mouth 118, and in the outer frame is a honeycomb shaped structure that allows air to pass through while protecting the filter 165 inside. The filter system could, alternatively, be used to cover only the air intake duct 151, rather than both the intake and exhaust ducts 151, 152. Having the single vent is advantageous over devices having multiple vents, such as in different sides of the device, because the single vent can reduce the number of components for venting while reducing the likelihood of ingress of particulates (e.g., dust, water, etc.) into the microwave.

The microwave 100 includes an internal frame or structure 103 that supports the outer housing 101 and retains internal components (e.g., electronic components), as well as providing other functionality. As shown in FIGS. 8 and 9, the internal structure 103 includes a first intermediate side wall 131, which extends behind or inside a (first) side panel 111 of the outer housing 101, and a second intermediate side wall 132, which extends behind or inside a (second) side panel 111 of the outer housing 101. Each of the first and second intermediate side walls 131, 132 are offset from the associated outer side panel 111, and a plurality of ribs 133 extend transverse to and between the inner and outer side walls. The ribs 133 increase the overall strength of the structure by forming a series of closed box sections with the intermediate and outer side walls while creating pockets that provide thermal insulation, among other things.

The illustrated internal structure 103 also includes a first inner side wall 135 located inside of the first intermediate side wall 131, a second inner side wall 136 located inside of the second intermediate side wall 132, a third inner side wall 137 opposite the door 115 and extending between the first and second inner side walls, a first inner end wall 138 located proximate to the inlet (e.g., filter) and interconnecting the inner side walls, and a second inner end wall 139 located proximate to electronic components and interconnecting the inner side walls. Together, these inner walls define an interior chamber 140 for receiving food/beverages through the open door 115 for heating when the door 115 is closed. The inner walls form a closed chamber (when the door is closed) and can be made of metal or other suitable material that helps shield (e.g., contain inside the chamber) the microwaves from the magnetron 120 while the microwave 100 is heating.

Also shown in FIGS. 8 and 9, surrounding the magnetron 120 and internal electronics are a first shielding wall 141, a second shielding wall 142, and a third shielding wall 143 interconnecting the first and second shielding walls 141, 142. The first shielding wall 141 extends from the first inner side wall 135 and/or the second inner end wall 139; and the second shielding wall 142 extends from the second inner side wall 136 and/or the second inner end wall 139. As shown in FIGS. 9 and 19, a fourth shielding wall 144 is located inside the of control panel 116 and interconnects the first, second, and third shielding walls at ends thereof. A fifth shielding wall can be located opposite the fourth shielding wall 144, but if provided, the fifth shielding wall includes openings for the first and second ducts 151, 152. The shielding walls form a chamber that houses the magnetron 120, as well as other components (e.g., fans, electronics, etc.) and can be made of metal or other suitable material that helps retain the microwaves from the magnetron 120 inside of the microwave 100. The shielding walls also increase the strength of the structure, such as by increasing impact strength to protect the components inside from damage.

The microwave 100 can include additional elements/components. For example, the microwave 100 can include an internal power supply (e.g., one or more batteries) and/or be configured to electrically couple to an external power supply (e.g., a power or electric cord). Features are provided to receive hold-down straps for the purpose securing the microwave oven while being transported, thereby potentially mitigating the impact to the microwave if it were to roll or slide. A thermal sensor can be employed to measure ambient temperature and limit operation of the device within allowable limits. A fluid sensing functionality can be added to prevent operation of the appliance in the event the appliance is residing in water (e.g., above a threshold amount or level) or is wet inside.

FIG. 21 is a perspective view of another exemplary embodiment of a portable microwave 200 (e.g., microwave oven) that is configurable the same as or similar to the microwave 100. The microwave 200 includes an outer housing 201 that cooperates with internal structure, such as that discussed above (e.g., internal walls and intermediate walls), to provide improved strength and durability as discussed herein. As shown, the outer housing 201 includes a plurality of walls or panels (e.g., outer walls/panels) interconnected with a plurality of corner panels 213. The illustrated plurality of walls includes a back panel 211 (e.g., back wall) and a side or end panel 212. One difference of the microwave 200 compared with the microwave 100 is the microwave 200 has a different ducting system. The microwave 200 includes an intake duct and an exhaust duct, which can be configured similar to the ducting discussed above for the microwave 100, except the intake duct has an inlet opening in the back panel 211 and the exhaust duct has an outlet opening in the end panel 212 (although the openings can be reversed). Thus, the inlet and outlet of the ducting are located in different walls of the plurality of outer walls. FIG. 21 illustrates a first cover 267, which covers the outlet opening in the end panel 212, and a second cover 268, which covers the inlet opening in the back panel 211. Accordingly, fresh air enters the microwave 200 through the second cover 268 and the inlet opening, passes through internal passages/compartments of the microwave 200, and exits the outlet opening and the first cover 267.

The microwave 200 includes a plurality of tie downs 214 located in one or more of the corner panels 213. Also shown in FIG. 21, each corner panel 213 includes a tie down 214 in each section or portion. Each tie down 214 includes a rod extending from two opposing inner sides of the associated corner panel 213, where the two opposing inner sides define an inner notch in the respective corner panel. The microwave 200 can be tied down through one or more of the tie downs 214, such as by passing a strap, cord, rope, etc. the inner notch and wrapping around the rod of the tie down 214.

As noted above, the microwaves disclosed herein are specifically designed for outdoor use or in an environment that is more subject to dust and moisture than a typical kitchen environment. Furthermore, the appliance is built to perform and withstand the transportation, storage, and use typically seen in moving the appliance from one location to another frequently. As well, the microwave oven has the added utility of performing in the second vertical orientation when placed on a floor or ground level surface. The physical orientation of the appliance makes its use easier or more ergonomic in nature (i.e. used on a kitchen counter, a microwave oven requires little to no physical bending or straining by the operator). Outside the kitchen (or countertop environment) a microwave oven may need to be placed on the floor or ground to operate—the vertical operation of the door eliminates some of the physical strain to operate.

Further, the microwaves disclosed herein, manage heat through a system that avoids heat build-up, which can lead to unsafe operation or failure of electronic components of an appliance. Additionally, a microwave oven that is moved or transported may be dropped, due to the heavy imbalanced weight, on its corner creating extra stress on the door hinge located on a corner. This stress could create a damaged hinge or latch that would render the microwave oven unusable as the door may not close or seal completely and activate a safety feature that de-activates the operation of the magnetron.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A portable microwave oven, comprising:
an outer housing comprising a plurality of outer walls comprising a side wall, which includes a first vent opening, and an end wall, which includes a second vent opening;
an inner structure comprising a plurality of inner walls that couple to the plurality of outer walls and define a heating chamber;
a door rotatable relative to the outer housing to access the heating chamber;
a heating element located inside the outer housing and configured to heat the heating chamber; and
a heat handling system comprising:
an intake duct fluidly connecting the first vent opening to an electronics chamber housing the heating element;
an exhaust duct fluidly connecting the electronics chamber to the second vent opening; and
at least one fan that is configured to draw air in through the intake duct or push air out through the exhaust duct.

2. The portable microwave oven of claim 1, wherein the side wall is opposite the door and the end wall is adjacent to each of the door and the side wall.

3. The portable microwave oven of claim 2, wherein the end wall is a first end wall and the plurality of outer walls comprises a second end wall, each of the first and second end walls includes a handle rotatably coupled to the associated end wall, and each handle is rotatable relative to the outer housing between a first position, in which the handle is positioned adjacent to the associated end wall, and a second position, in which the handle is positioned transversely to the associated end wall.

4. The portable microwave oven of claim 1, wherein the inner structure comprises a plurality of intermediate walls, each intermediate wall being positioned between an associated wall of each of the plurality of outer walls and the plurality of inner walls.

5. The portable microwave oven of claim 4, wherein the plurality of intermediate walls comprises:
a first intermediate side wall extending behind and inside of a first outer side wall of the plurality of outer walls;
a second intermediate side wall extending behind and inside of a second outer side wall of the plurality of outer walls, wherein each of the first and second intermediate side walls is offset from the associated first or second outer side wall;
a first plurality of ribs extending transversely to and between the first outer side wall and the first intermediate side wall, such that each rib of the first plurality of ribs forms a series of closed box sections with the first outer side wall and the first intermediate side wall; and
a second plurality of ribs extending transversely to and between the second outer side wall and the second intermediate side wall, such that each rib of the second plurality of ribs forms a series of closed box sections with the second outer side wall and the second intermediate side wall.

6. The portable microwave oven of claim 5, wherein the plurality of inner walls comprises:
a first inner side wall located inside of the first intermediate side wall;
a second inner side wall located inside of the second intermediate side wall;
a third inner side wall opposite the door and extending between and interconnecting the first and second inner side walls;
a first inner end wall located proximate to the side wall having the first vent opening; and
a second inner end wall located proximate to electronic components and interconnecting the inner side walls together.

7. The portable microwave oven of claim 1, wherein the microwave oven is operable in a first orientation, in which the door is forward facing, and a second orientation, in which the door is upward facing, and wherein the microwave open provides a cooking performance in each of the first and second orientations without a significant degradation of performance.

8. The portable microwave oven of claim 1, further comprising a plurality of corner panels interconnecting adjacent walls of the plurality of outer walls.

9. The portable microwave oven of claim 8, wherein at least two of the plurality of corner panels includes a tie down comprising a rod extending from two opposite inner sides, which define an inner notch in the respective corner panel, and through the inner notch.

10. A portable microwave oven, comprising:
an outer housing comprising a plurality of outer walls comprising a first outer wall, which includes a vent opening;
an inner structure comprising a plurality of inner walls that define a heating chamber;
a door rotatable relative to the outer housing to access the heating chamber;
a heating element located inside the outer housing and configured to heat the heating chamber; and
a heat handling system comprising:
an intake duct fluidly connecting the vent opening to an electronics chamber housing the heating element;
an exhaust duct fluidly connecting the electronics chamber to the vent opening; and
at least one fan that is configured to draw air in through the intake duct or push air out through the exhaust duct.

11. The portable microwave oven of claim 10, wherein the microwave oven is operable in a first orientation, in which the door is forward facing, and a second orientation, in which the door is upward facing

12. The portable microwave oven of claim 10, wherein the exhaust duct and the intake duct extend adjacent to one another and each is positioned between the plurality of outer walls and the plurality of inner walls.

13. The portable microwave oven of claim 12, wherein each duct comprises a first section, which extends parallel to the first outer wall, and a second section, which extends transversely to the first section.

14. The portable microwave oven of claim 13, wherein air enters the intake duct through an inlet of the vent opening, passes through the first section of the intake duct, then turns transversely passing through the second section of the intake duct, then into an internal chamber housing electronic components to cool the electronic components in the internal chamber.

15. The portable microwave oven of claim 14, wherein the air passes from the internal chamber into the second section of the exhaust duct, then turns transversely passing through the first section of the exhaust duct, then exits through an outlet of the vent opening.

16. A portable microwave oven, comprising:
an outer housing comprising a plurality of outer walls;
an inner structure comprising:
a plurality of inner walls that define a heating chamber; and
a plurality of intermediate walls, each intermediate wall being positioned between an associated wall of each of the plurality of outer walls and the plurality of inner walls,
wherein the inner structure couples to the outer housing;
a door rotatable relative to the outer housing to access the heating chamber; and
a heating element located inside the outer housing and configured to heat the heating chamber.

17. The portable microwave oven of claim 16, wherein the plurality of intermediate walls comprises:
a first intermediate side wall extending behind and inside of a first outer side wall of the plurality of outer walls;
a second intermediate side wall extending behind and inside of a second outer side wall of the plurality of outer walls, wherein each of the first and second intermediate side walls is offset from the associated first or second outer side wall;
a first plurality of ribs extending transversely to and between the first outer side wall and the first intermediate side wall, such that each rib of the first plurality of ribs forms a series of closed box sections with the first outer side wall and the first intermediate side wall; and
a second plurality of ribs extending transversely to and between the second outer side wall and the second intermediate side wall, such that each rib of the second plurality of ribs forms a series of closed box sections with the second outer side wall and the second intermediate side wall.

18. The portable microwave oven of claim 17, wherein the plurality of inner walls comprises:
a first inner side wall located inside of the first intermediate side wall;
a second inner side wall located inside of the second intermediate side wall;
a third inner side wall opposite the door and extending between and interconnecting the first and second inner side walls;
a first inner end wall interconnecting the inner side walls together; and
a second inner end wall located proximate to electronic components and interconnecting the inner side walls together.

19. The portable microwave oven of claim 18, further comprising a heat handling system comprising:
an intake duct fluidly connecting a first vent opening in a first wall of the plurality of outer walls to an electronics chamber housing the heating element; and
an exhaust duct fluidly connecting the electronics chamber to a second vent opening in a second wall of the plurality of outer walls.

20. The portable microwave oven of claim 16, further comprising:
a first handle rotatably coupled to a first wall the outer housing; and
a second handle rotatably coupled to a second wall of the outer housing,
wherein the microwave oven is movable between a first orientation, in which the door is horizontally facing, and a second orientation, in which the door is vertically facing, through the first and second handles.
